(19) United States
(12) Patent Application Publication
(10) Pub. No.: US 2017/0233108 A1
(43) Pub. Date: Aug. 17, 2017

(54) Aircraft Weight and Balance Tool System

(71) Applicant: AIRSUITE Inc., Thunder Bay (CA)

(72) Inventor: Michael Kleywegt, Thunder Bay (CA)

(21) Appl. No.: 15/350,765

(22) Filed: Nov. 14, 2016

Related U.S. Application Data
(60) Provisional application No. 62/255,037, filed on Nov. 13, 2015.

(51) Int. Cl. B64F 5/60; G01M 1/02; G01G 19/08; G07C 5/00; B64F 5/40

(52) U.S. Cl. CPC B64F 5/60; G07C 5/008; B64F 5/40; G01G 19/08; G01M 1/02; H04L 67/12

(57) ABSTRACT

An aircraft weight and balance data management system includes a central server storing weight and balance data thereon which communicates over a communications network with computer devices belonging to both pilot and maintenance persons respectively. The system i) receives up to date data from maintenance persons, ii) calculates weight and balance specifications for aircraft according to data from maintenance persons, iii) communicates the specifications to a pilot, and iv) calculates variations to the specifications for a loaded aircraft for all fuel burn scenarios. The system communicates up to date weight and balance information relating to large numbers of aircraft configurations to a central location such that all maintenance personnel and pilots have access to the same up to date information.

This application claims the benefit under 35 U.S.C.119(e) of U.S. provisional application Ser. No. 62/255,037, filed Nov. 13, 2015.

### FIELD OF THE INVENTION

The present invention relates to an aircraft weight and balance data management system for i) receiving up to date aircraft weight and balance data from maintenance persons, ii) calculating weight and balance specifications for one or more aircraft according to the weight and balance data from maintenance persons, iii) communicating the calculated weight and balance specifications to a pilot, and iv) calculating variations to the weight and balance specifications for a loaded aircraft for all fuel burn scenarios, and more particularly the present invention relates to an aircraft weight and balance data management system in which the weight and balance information is stored on a central server so as to be independently accessible by both by maintenance persons and pilots respectively.

### BACKGROUND

Rules relating to operation of aircraft require that operators of the aircraft generate an operational flight plan which includes itinerary information along with various additional data which may include aircraft identification, GPS tracking information, pilot identification, a passenger manifest, a listing of dangerous goods, a route plan, a fuel plan, and weight and balance information relating to the configuration of the aircraft and any loadable items including passengers and cargo. A copy of the flight plan must be filed with air traffic regulating authorities.

The generation of accurate weight and balance information for each aircraft is cumbersome to generate and difficult to keep up to date between numerous maintenance persons and numerous pilots associated with an operator, even when the operator is small in size and only operates a limited number of aircraft, in view of the large number of optional configurations that each aircraft can be operated in and the large variability of cargo between different flights of the aircraft.

### SUMMARY OF THE INVENTION

According to one aspect of the invention there is provided an aircraft weight and balance data management system for communicating aircraft weight and balance data between at least one aircraft maintenance person and at least one pilot, the system comprising:

a central server adapted to store weight and balance data thereon including an aircraft listing of available aircraft, weight and balance data associated with each available aircraft in the aircraft listing, a master equipment listing of auxiliary equipment items available to be installed on one or more of the available aircraft in the aircraft listing, weight and balance data associated with each auxiliary equipment item, and for each aircraft, a selectable equipment listing of auxiliary equipment items which are available to be installed on that aircraft;

a user computer device associated with said at least one pilot;

a user computer device associated with said at least one aircraft maintenance person;

a communications interface associated with each one of the central server and the user computer devices and adapted to enable exchange of data between the central server and the user computer devices;

a maintenance processing routine executable on the user computer device associated with said at least one aircraft maintenance person so as to be adapted to:
i) receive updated weight and balance data input by said at least one maintenance person, and
ii) amend the weight and balance data of the aircraft listing and the master equipment listing stored on the central server using the communications interface according to the updated weight and balance data input by said at least one maintenance person;

a weight and balance routine executable on at least one of the computer server or the user computer device associated with said at least one aircraft maintenance person so as to be adapted to:
i) for each aircraft, calculate weight and balance specifications for each installation combination of the auxiliary equipment items which are available to be installed on that aircraft according to the selectable equipment listing using the corresponding weight and balance data stored on the server, and
ii) store the calculated weight and balance specifications of all installation combinations for each aircraft on the server;

a pilot processing routine executable on the user computer device associated with said at least one pilot so as to be adapted to:
i) receive the calculated weight and balance specifications for each aircraft of the aircraft listing from the central server using the communications interface,
ii) receive an aircraft selection through an input on the user computer device associated with the pilot corresponding to one selected aircraft from the available aircraft,
iii) receive an equipment selection through the input on the user computer device associated with the pilot so as to identify a corresponding installation combination of the auxiliary equipment items installed on the aircraft,
iv) receive weight and balance data relating to at least one loadable item through the input on the user computer device associated with the pilot, and
v) calculate a fuel burn variation of the weight and balance of the aircraft throughout a range of fuel burn using the weight and balance specifications of the corresponding installation combination and the weight and balance data relating to said at least one loadable item, and
vi) indicate on a display of the user computer device associated with the pilot if any portion of the fuel burn variation of the weight and balance falls outside of allowable weight and balance limits for the aircraft.

The system described herein provides an effective means to communicate up to date weight and balance information relating to large numbers of aircraft configurations to a central location such that all maintenance personnel and pilots have access to the same up to date information. The information is also presented in an efficient manner to enable proper judgment by the pilot to ensure safety requirements are met despite the large variety of possible cargo and aircraft configurations.

The pilot processing routine may be further adapted to identify designated loading locations on a display of the user computer device associated with the pilot, and receive a weight associated with each designated location through the input of the user computer device associated with the pilot such that the designated loading locations and the associated input weight define said weight and balance data relating to at least one loadable item. Preferably at least some of the designated loading locations correspond to individual passenger locations of the aircraft and the associated input weight corresponds to weight of a corresponding passenger, while at least another one of the designated loading locations corresponds to a cargo location of the aircraft and the associated input weight corresponds to weight of a loadable cargo item.

Preferably the pilot processing routine is further adapted to graphically display the designated loading locations relative to a layout of the aircraft, and associate the input weight with each designated location by selecting the designated location on the graphical display. The weight and balance limits for the aircraft may be displayed as a boundary on a graphical representation of weight versus balance, and wherein the fuel burn variation of the weight and balance is plotted on said graphical representation to visually indicate if any portion of the plotted fuel burn variation of the weight and balance extends outside of the boundary.

Preferably the pilot processing routine displays a first graphical representation of weight versus fore-aft balance with the fuel burn variation of the weight and balance plotted thereon and a second graphical representation of weight versus left-right balance with the fuel burn variation of the weight and balance plotted thereon.

When the user computer device associated with the pilot communicates with the central server over a communications network, the pilot processing routine may be adapted to execute step i) only when the user computer device associated with the pilot is in communication with the communications network, however, the pilot processing routine may be adapted to execute steps ii) through vi) even when the user computer device associated with the pilot is not in communication with the communications network.

Preferably the weight and balance routine is further adapted to display the calculated weight and balance specifications of all installation combinations in a matrix form on a specification sheet for each aircraft. Preferably the specification sheet further includes an indication of conflicting auxiliary equipment items for that aircraft, and a unique identification number associated with each installation combination.

Preferably the weight and balance routine is further adapted to generate for each aircraft a graphical representation of weight versus balance and plot on the graphical representation: i) a rearwardmost center-of-gravity of all installation combinations relative to a permissible fore-aft range corresponding to the heaviest installation combination, and ii) a forwardmost center-of-gravity of all installation combinations relative to a permissible fore-aft range corresponding to the lightest installation.

According to a second aspect of the present invention there is provided an aircraft weight and balance data management system for communicating aircraft weight and balance data between at least one aircraft maintenance person and at least one pilot, the system comprising:

a central server adapted to store weight and balance data thereon including an aircraft listing of available aircraft, weight and balance data associated with each available aircraft in the aircraft listing, a master equipment listing of auxiliary equipment items available to be installed on one or more of the available aircraft in the aircraft listing, weight and balance data associated with each auxiliary equipment item, and for each aircraft, a selectable equipment listing of auxiliary equipment items which are available to be installed on that aircraft;

a user computer device associated with said at least one pilot;

a user computer device associated with said at least one aircraft maintenance person;

a communications interface associated with each one of the central server and the user computer devices and adapted to enable exchange of data between the central server and the user computer devices over a communications network;

a maintenance processing routine executable on the user computer device associated with said at least one aircraft maintenance person so as to be adapted to:
i) receive updated weight and balance data input by said at least one maintenance person, and
ii) amend the weight and balance data of the aircraft listing and the master equipment listing stored on the central server using the communications interface according to the updated weight and balance data input by said at least one maintenance person;

a weight and balance routine executable on at least one of the computer server or the user computer device associated with said at least one aircraft maintenance person so as to be adapted to:
i) for each aircraft, calculate weight and balance specifications for each installation combination of the auxiliary equipment items which are available to be installed on that aircraft according to the selectable equipment listing using the corresponding weight and balance data stored on the server, and
ii) store the calculated weight and balance specifications of all installation combinations as a specification sheet for each aircraft on the server;

a pilot processing routine executable on the user computer device associated with said at least one pilot so as to be adapted to:
i) receive the specification sheet for each aircraft from the central server using the communications interface,
ii) receive an aircraft selection through an input on the user computer device associated with the pilot corresponding to one selected aircraft from the available aircraft,
iii) display the specification sheet for the selected aircraft on the user computer device associated with the pilot.

Preferably the specification sheet for each aircraft includes the calculated weight and balance specifications for each installation combination displayed thereon as a matrix.

Preferably the specification sheet includes the calculated weight and balance specifications for each installation combination displayed thereon with an indication of conflicting auxiliary equipment items for that aircraft.

Preferably the specification sheet for each aircraft includes the calculated weight and balance specifications for each installation combination displayed thereon with a unique identification number associated with each installation combination.

### BRIEF DESCRIPTION OF THE DRAWINGS

One embodiment of the invention will now be described in conjunction with the accompanying drawings in which:

FIG. 1 is a schematic representation of the overall aircraft weight and balance data management system;

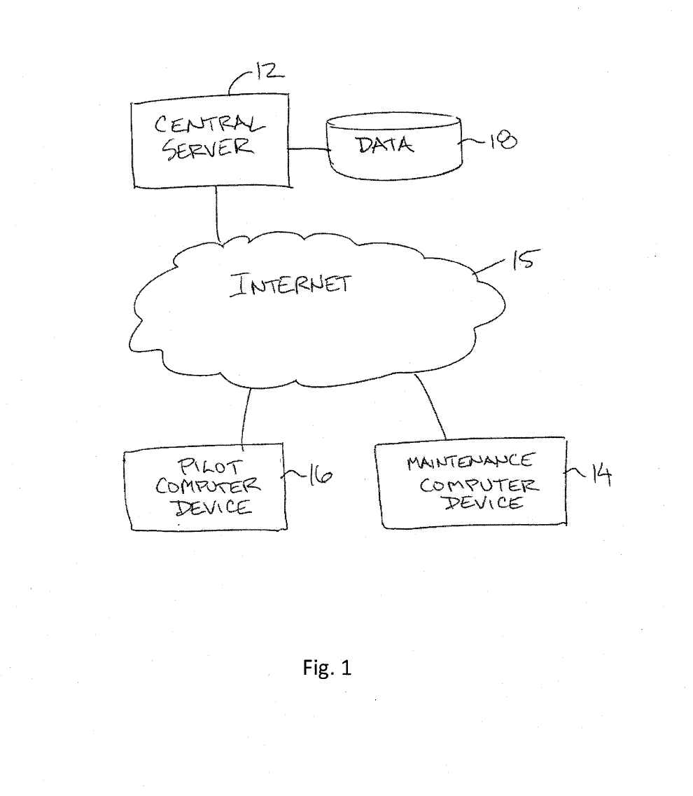

FIG. 2 is a flowchart representing the maintenance processing routine and the weight and balance processing routine of the system;

FIG. 3 is a flowchart representing the pilot processing routine executed on the pilot computer device;

FIG. 4 is a screenshot of the master equipment list;

FIG. 5 is a screenshot of the options provided for adding new equipment to the master equipment list;

FIG. 6 is a screenshot of the options provided for identifying conflicts of new equipment added;

FIG. 7 is a screenshot of a listing of available aircraft providing options to add new aircraft;

FIG. 8 is a screenshot of the specifications which can be designated for each new aircraft being added;

FIG. 9 is a listing of optionally installed equipment from the master equipment list which may be optionally installed on the selected aircraft;

FIG. 10 is a screenshot of all installed equipment associated with a selected aircraft;

FIG. 11 is a screenshot summarizing all weight and balance specifications associated with a selected aircraft including original scaling data of the aircraft and subsequent amendments, as well as illustrating the options provided for specifying each installed item;

FIG. 12 is a screenshot of the overall weight and balance specification sheet produced by the weight and balance routine which is associated with a single designated aircraft for subsequent use by the pilot processing routine;

FIG. 13 is a screenshot of an initial menu presented to the pilot when creating a new flight file;

FIG. 14 is a screenshot of the available aircraft from which the pilots can select;

FIG. 15 is a screenshot illustrating the optionally installed equipment that the pilot can select from when configuring the aircraft for a designated flight;

FIG. 16 is a screenshot of the graphical representation of the designated loading locations as well as a resulting graphical representation of the variation of the centre of gravity and weight resulting from fuel burn;

FIG. 17 is a screenshot of an overall summary of the weight and balance specifications selected by the pilot and used for calculation of the graphical representation of the fuel burn variation to the weight and balance; and

FIG. 18 is a screenshot of the weight and balance summary displayed by the pilot processing routine for review by the pilot prior to completion of the creation of a new flight file.

In the drawings like characters of reference indicate corresponding parts in the different figures.

### DETAILED DESCRIPTION

Referring to the accompanying Figures, there is illustrated an aircraft weight and balance data management system generally indicated by reference numeral 10. The system is suited for communicating aircraft weight and balance data between a central server 12, maintenance persons operating respective maintenance computer devices 14 and pilots operating respective pilot computer devices 16.

The central server 12 takes the form of one or more computers operating from one or more respective locations to collectively perform the functions outlined in the following. The central server is typically a cloud based server having a communication interface adapted to exchange data between the central server and a communications network 15, for example the Internet. The central server 12 includes at least one processor and at least one data storage location comprising a memory storing relevant data thereon used by the system.

Typical information stored on the central server includes an aircraft listing corresponding to a list of available aircraft associated with a particular client, a master equipment listing consisting of auxiliary equipment items available to the client to be installed on one or more of the available aircraft in the aircraft listing, as well as weight and balance data associated with each available aircraft and associated with each auxiliary equipment item. Each aircraft also includes a selectable equipment listing associated therewith which lists the auxiliary equipment items from the master list which are available to be installed on that particular aircraft.

The maintenance computer device 14 comprises a personal computer device such as a desktop computer station, a portable computer, a tablet computer, or a mobile smart phone for example. In each instance the computer includes a memory storage for storing data thereon including programming for executing various functions of the maintenance computer device as described in the following. The computer device further includes a suitable input, for example a touchscreen, a keyboard, or a mouse and the like, as well as a suitable output in the form of a display screen for example. The computer device further includes a communications interface which is adapted to enable exchange of data between the maintenance computer device 14 and the communications network 15 so as to be adapted to exchange data between the central server and the maintenance computer device.

The programming stored on the maintenance computer device and which is executable thereon includes i) a maintenance processing routine and ii) a weight and balance routine which are adapted to perform various functions as described in the following. In brief, the maintenance processing routine is adapted to receive updated weight and balance data input by a maintenance person using the maintenance computer device to add or amend the weight and balance data associated with the aircraft and auxiliary equipment items found in the aircraft listing and the master equipment listing stored on the central server by exchanging information over the communications network.

The weight and balance routine executable on the maintenance computer device, or optionally on the computer server in alternative arrangements, is adapted to, for each aircraft, calculate weight and balance specifications for each installation combination of auxiliary equipment items which are available to be installed on that aircraft according to the selectable equipment listing using the corresponding weight and balance data stored on the server. The weight and balance routine is further arranged to store the calculated weight and balance specifications of all installation combinations for each aircraft on the server in the form of a specification sheet described in further detail below.

The pilot computer device 16 is also a personal computer device such as a desktop computer station, a portable computer, a tablet computer, or a mobile smart phone for example. Again, in each instance the computer includes a memory storage for storing data thereon including programming for executing various functions of the pilot computer device as described in the following. The computer device further includes a suitable input, for example a touchscreen, a keyboard, or a mouse and the like, as well as a suitable output in the form of a display screen for example. The computer device further includes a communications interface which is adapted to enable exchange of data between the pilot computer device 16 and the communications network 15 so as to be adapted to exchange data between the central server and the pilot computer device.

The programming stored on the pilot computer device and which is executable thereon includes a pilot processing routine which is adapted to perform various functions as described in the following. The pilot processing routine executable on the pilot computer device 16 is adapted to retrieve the calculated weight and balance specifications for all aircraft of the aircraft listing from the central server using the communications interface over the communications network 15 such that all relevant data is stored locally on the pilot computer device to perform subsequent operations online or offline and disconnected from the communications network 15 if desired. Subsequent operations by the pilot processing routine include receiving an aircraft selection through an input on the pilot computer device corresponding to one selected aircraft from the list of available aircraft, followed by receiving an equipment selection through the input on the pilot computer device so as to identify a corresponding installation combination of the auxiliary equipment items installed on the relevant aircraft selected by the pilot. The pilot processing routine then prompts the pilot to include weight and balance data relating to any loadable items, for example passengers, cargo and fuel. The pilot processing routine on the pilot computer device then calculates a variation of the overall weight and balance of the loaded aircraft as the fuel is consumed from a full fuel tank to an empty fuel tank during flight. The pilot processing routine is then able to indicate on the display of the pilot computer device if any portion of the fuel burn variation of the weight and balance falls outside of allowable weight and balance limits for the aircraft.

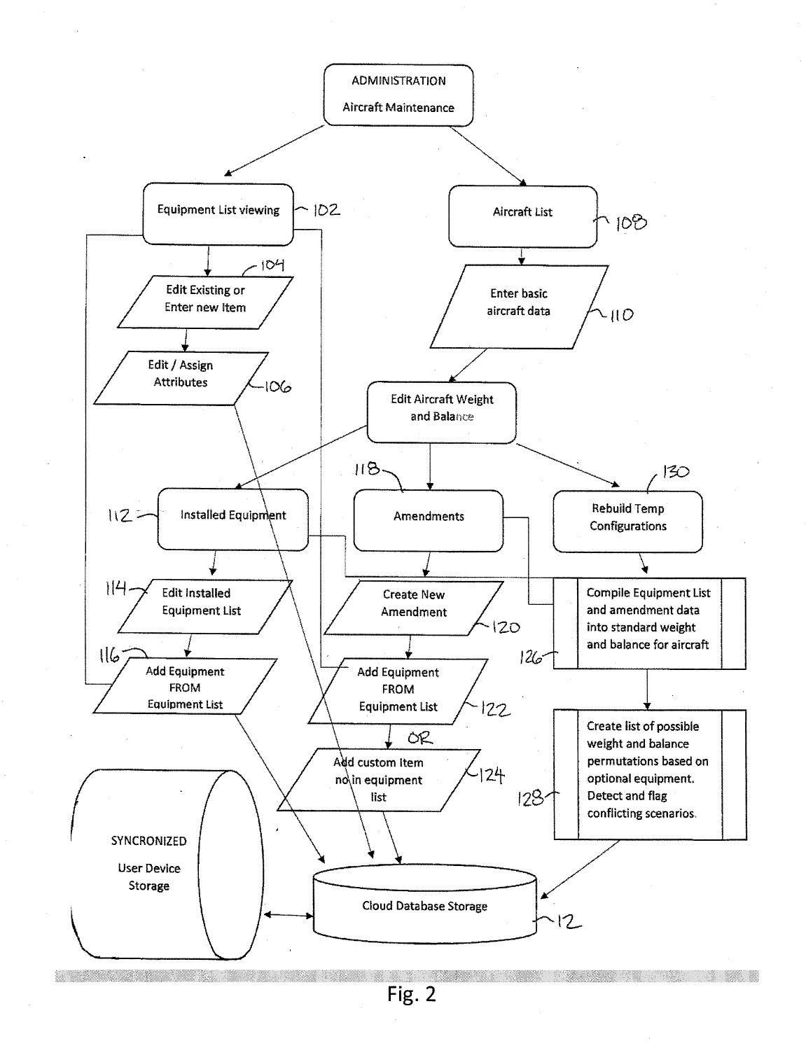

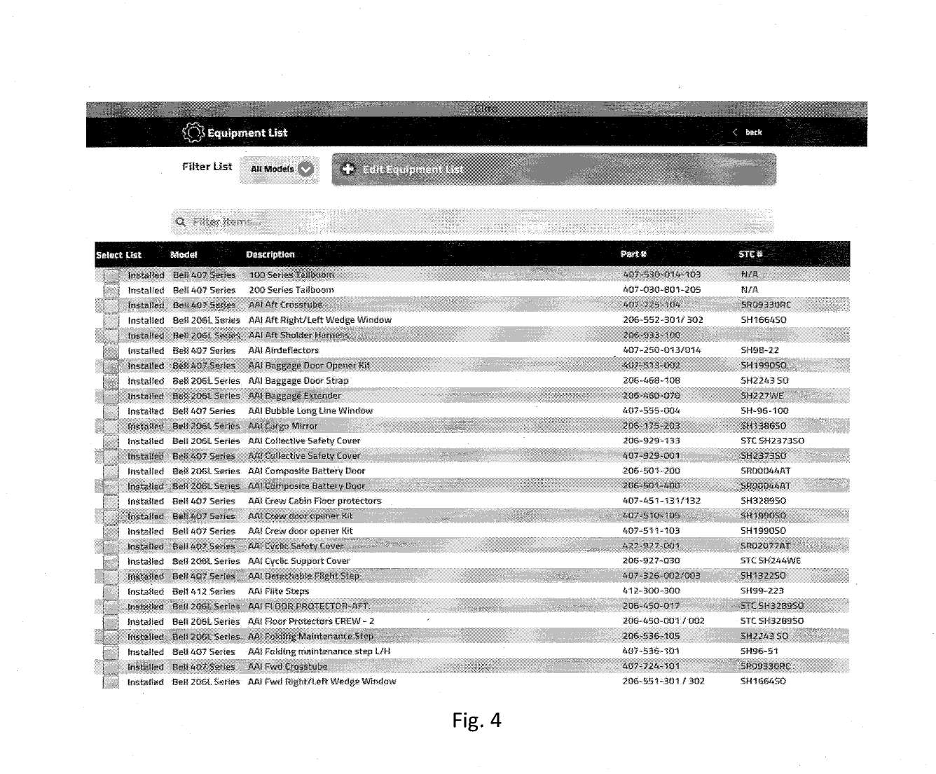

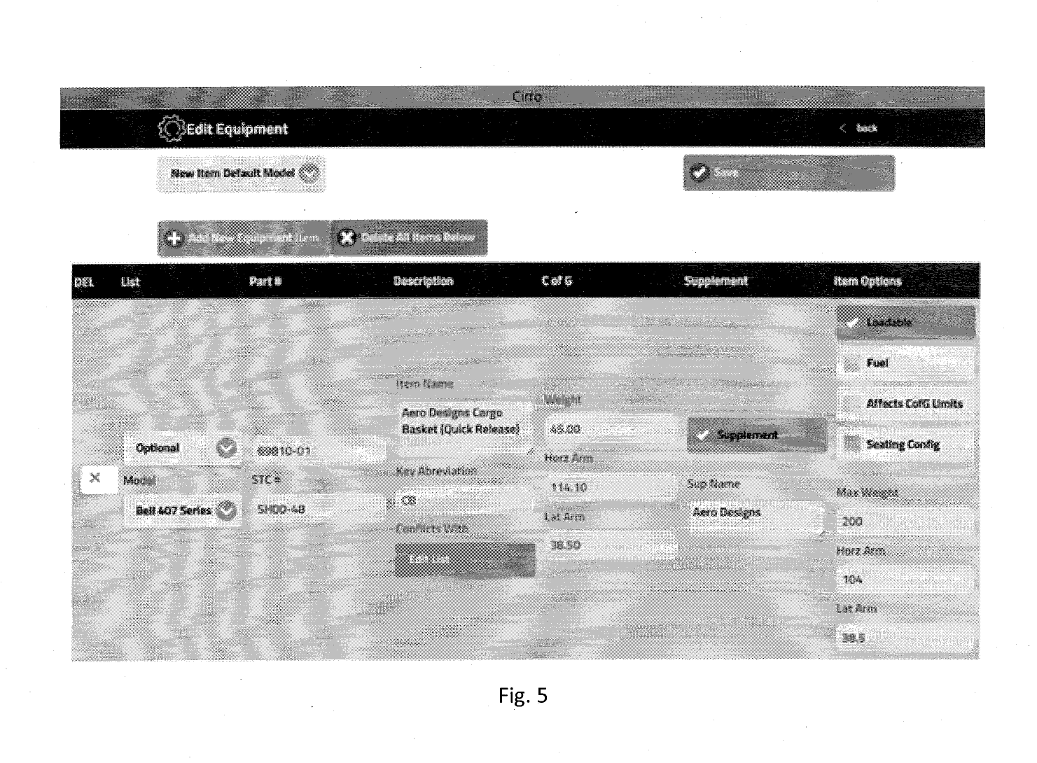

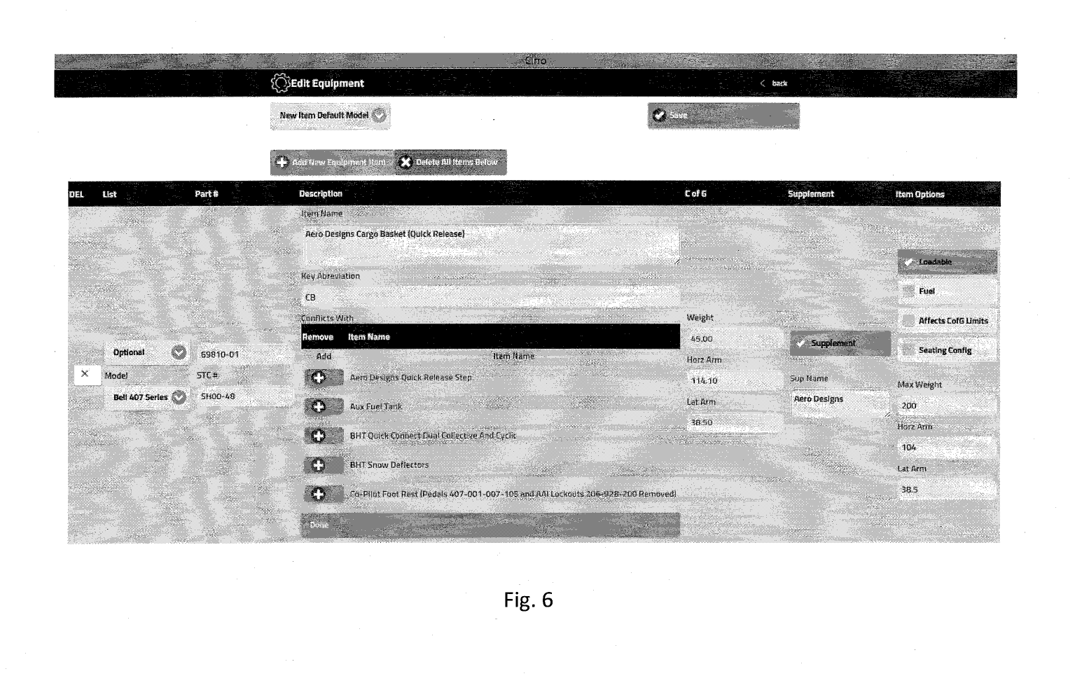

Turning now more particularly to FIG. 2, the maintenance processing routine, and the weight and balance processing routine will now be described in further detail. Upon initial activation of the maintenance processing routine, the maintenance computer device retrieves the most up-to-date weight and balance information from the central server over the communications network. The maintenance person is then able to view the master equipment listing at step 102 and is presented with the option of editing weight and balance information associated with any listed item or the option of entering a new item at step 104. A screenshot of an exemplary master equipment list is shown in FIG. 4. As shown in FIG. 5, for each new auxiliary equipment item added, specifications are entered with regard to the applicable aircraft, the identification of the item by a serial number, the weight of the item, the horizontal arm corresponding to the forward and aft balance, and the lateral arm corresponding to the left and right balance relative to the centre of gravity of the aircraft. Each equipment item can further be designated as being loadable for example by cargo or a passenger, or whether it contains fuel which is consumed during flight. As further shown in FIG. 6, the maintenance person is further enabled to identify what other equipment items from the master list would conflict either by physical interference or by resulting in an uncertified configuration of the aircraft. The editing of existing attributes or the assignment of new attributes is shown at step 106 in FIG. 2. Any amendments entered will be synchronized and updated to the corresponding weight and balance data stored on the central server immediately if the maintenance computer remains connected to the communications network, however the updates will instead be synchronized at a later date if no immediate network connection is available.

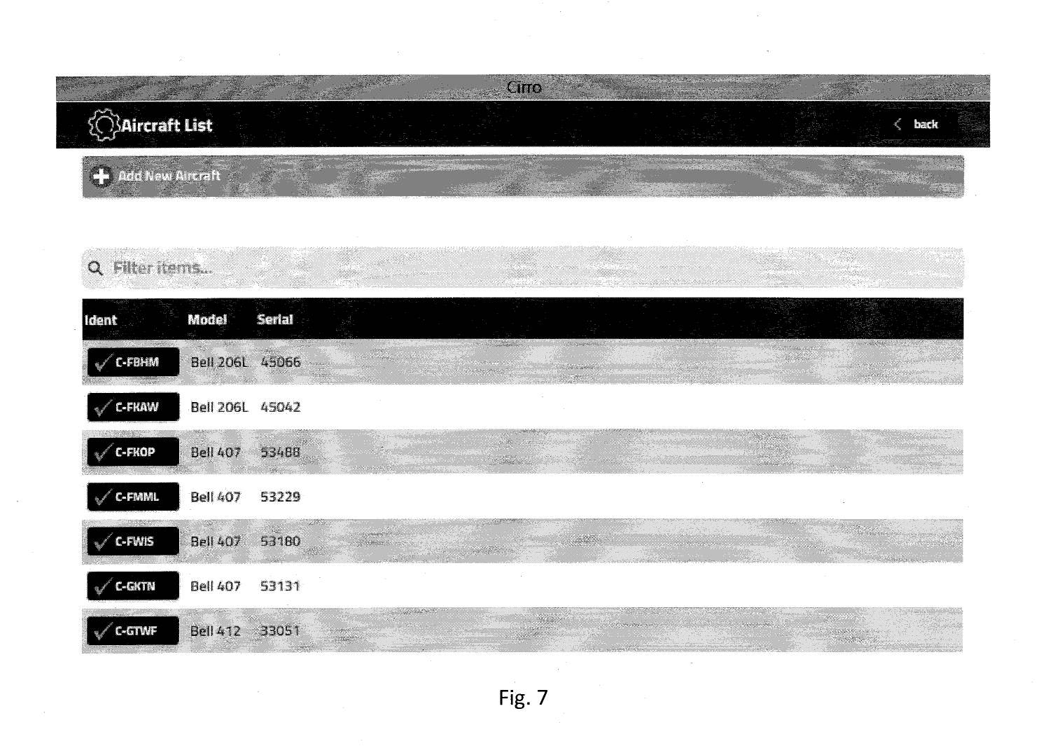

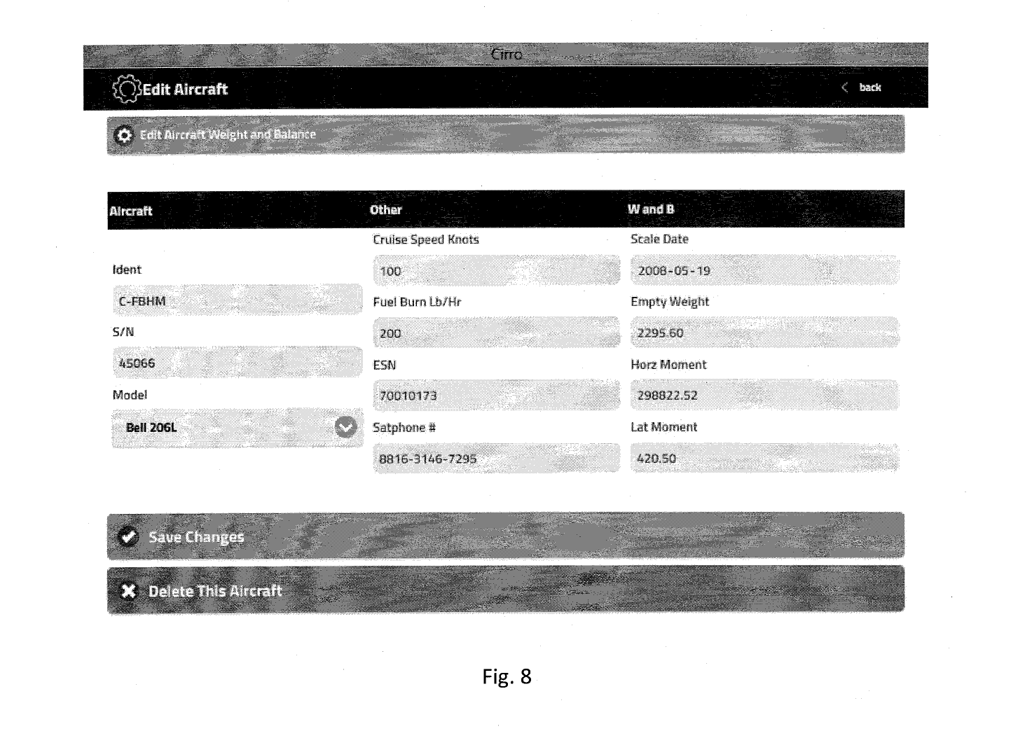

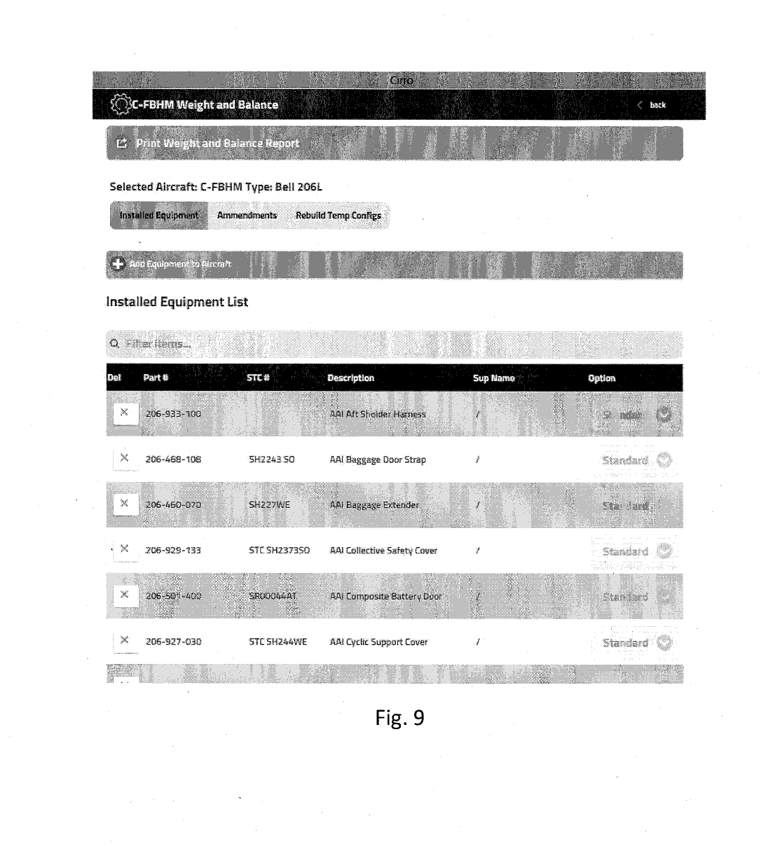

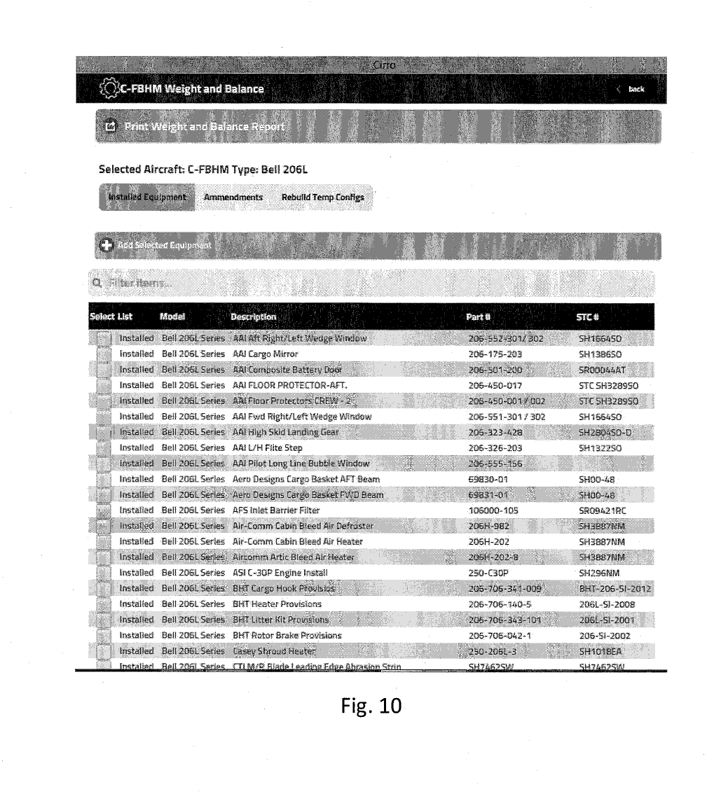

The maintenance processing routine is also adapted to list all available aircraft in an aircraft listing as shown at step 105 and as represented by the screenshot shown in FIG. 7. For each aircraft listed, the maintenance person enters through their maintenance computer device basic aircraft data as shown at step 110 and as represented in the screenshot shown in FIG. 8. Basic information includes the scaling data of the aircraft, the date of the scaling, the weight and the horizontal and lateral arms of the centre of gravity resulting from the scaling, the aircraft identification by serial number and model number, the cruise speed of the aircraft, the fuel burn rate of the aircraft, the GPS signature of the aircraft, and a satellite phone number of the aircraft if the available, etc. Each aircraft file also includes a respective equipment list associated therewith which lists auxiliary equipment items from the master equipment list which are available to be installed on that respective aircraft. An example of the installable equipment for the selected aircraft is shown in FIG. 9. If it is desired to include additional equipment which may be optionally installed on that particular aircraft, a maintenance person has the option of using the maintenance processing routine on the maintenance computer device 14 to open the master equipment list and select items from that list to be installed on the given aircraft as shown in the screenshot of FIG. 10. The various steps of viewing the installed equipment at step 112, editing the available equipment to be installed on the given aircraft at step 114, and the addition of new equipment to a particular aircraft's equipment listing at step 116 are followed by updating of the corresponding weight and balance data and aircraft equipment listing stored on the central server 12.

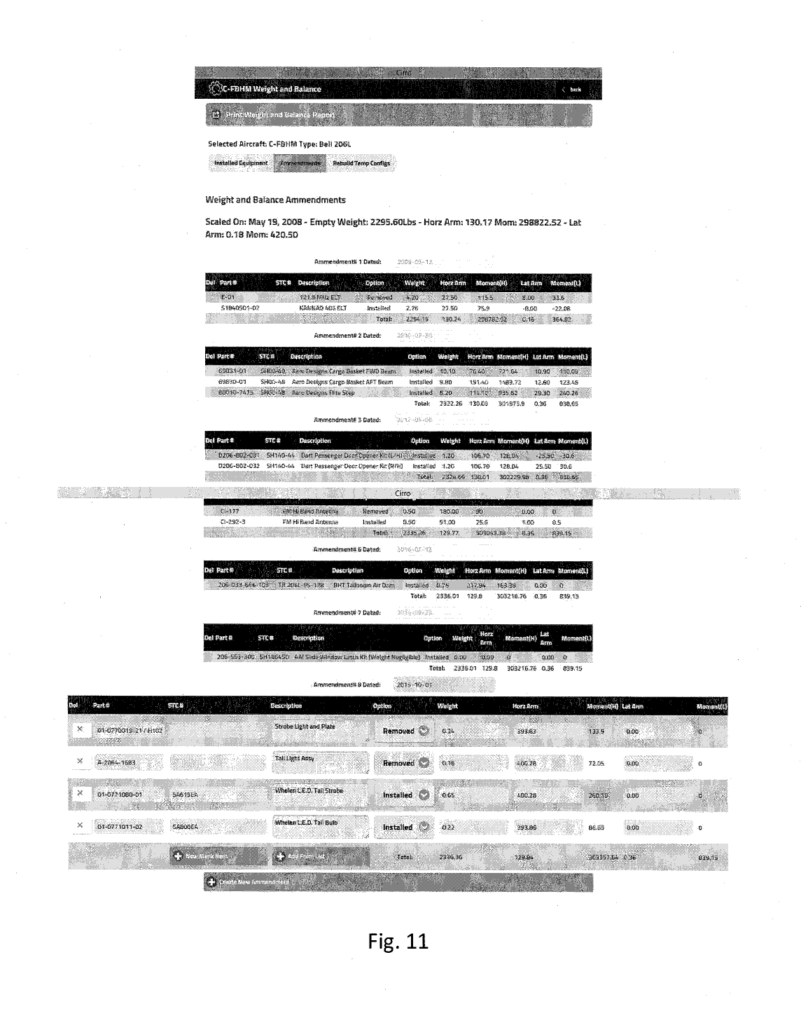

The maintenance processing routine on the maintenance computer device is further adapted to enable amendments to the scaling of the aircraft to be added to the weight and balance data, for example resulting from the replacement of various parts on the aircraft or other possible modifications of the aircraft during routine maintenance for example. Amendments are initiated by selecting the amendments as shown in the screenshot of FIG. 11 and represented at step 118 in FIG. 2. For each amendment to the aircraft, for example by the removal of one component, or the addition of another, each component is identified by serial number and the corresponding weight and balance data such as a weight and a horizontal arm and a lateral arm are entered through the input of the maintenance computer device 14 when creating a new amendment at step 120. In some instances the equipment being added may already be a known component entered on the master equipment list such that the amendment involves simply selecting a known component from the master equipment list at step 122, however in other instances if a new or custom amendment must be entered as shown at step 124 the corresponding weight and balance data must be entered by the maintenance person.

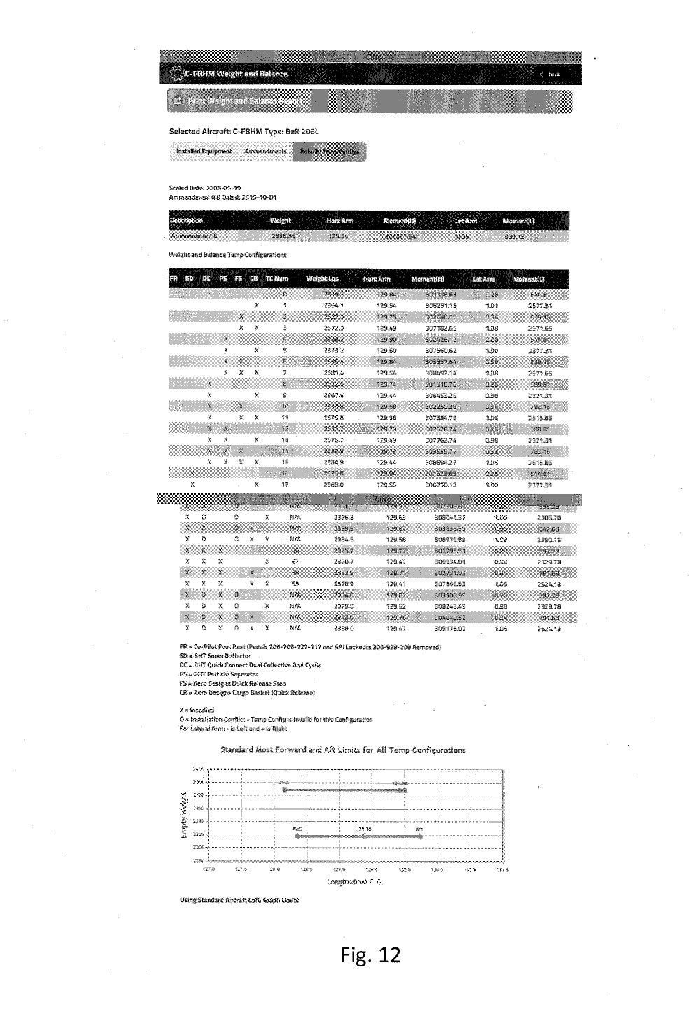

Once the updates have been entered, the weight and balance processing routine is executed on the maintenance computer device 14 to calculate weight and balance specifications for each unique combination of optionally installed equipment. The optionally installed equipment list corresponds only to equipment items which are optionally removed for some flight configurations of the aircraft but which excludes equipment items added by way of amendment to the scaling of the aircraft as a whole and which are considered to be permanent modifications to the aircraft. The calculated weight and balance specifications for each installation combination corresponds to the overall configured weight of the aircraft, a horizontal arm, and a lateral arm which define the centre of gravity of the aircraft as well as the resulting moments in the horizontal and lateral directions respectively. The calculated weight and balance specifications for each installation combination are then listed in a single specification sheet in a matrix form identifying the combination of installed equipment for each installation combination. Any conflicting installation items are also readily visually identified within the matrix. Each installation configuration is also identified by a unique identification serial number. The compilation of the spec sheet for each aircraft and the listing of all combinations in a matrix form within the specification sheet are shown at steps 126 and 128 in FIG. 2 following the user selection of the rebuild temp configurations tab 130 as shown in the screenshot of FIG. 12.

In addition to the use of a matrix to graphically display all installation combinations of optional equipment on the selected aircraft, the weight and balance routine is further adapted to generate a graphical representation of weight versus balance as shown in the lower portion of the FIG. 12 screenshot. In this instance the empty weight of the aircraft is shown along the vertical axis and the longitudinal centre of gravity variation is shown along the horizontal axis. The weight and balance routine plots on the graphical representation a permissible fore-aft range of the centre of gravity of the aircraft when the aircraft weight corresponds to the heaviest installation combination of all installation combinations in the above matrix as represented by line 200. A rearwardmost position of the centre of gravity among all installation configurations is then plotted along that same weight level as reference point 202. The weight and balance routine also plots on the graphical representation, a permissible fore-aft range of the centre of gravity of the aircraft when the aircraft weight corresponds to the latest installation combination of all installation combinations in the above matrix as represented by line 204. The forwardmost position of the centre of gravity among all installation configurations is then plotted along that same weight level as reference point 206. The maintenance person can then visually identify that the reference point 202 is within the limits of line 200 and that the reference point 206 is within the limits of the line 204 which confirms that the aircraft is suitably balanced for all possible installation combinations.

In the event that the aircraft is not suitably balanced for all possible installation combinations, maintenance persons have the opportunity to add ballast to the aircraft at required locations to ensure that the balance of the aircraft is within applicable limits for all loading configurations. When ballast is added, the ballast item is recorded as an amendment to the weight and balance scaled data of the aircraft at steps 118 through 124. The operator then again selects the rebuild temp configurations tab at step 130 to enable a new specification sheet and graphical representation to be generated at steps 126 and 128, and according to the screenshot at FIG. 12.

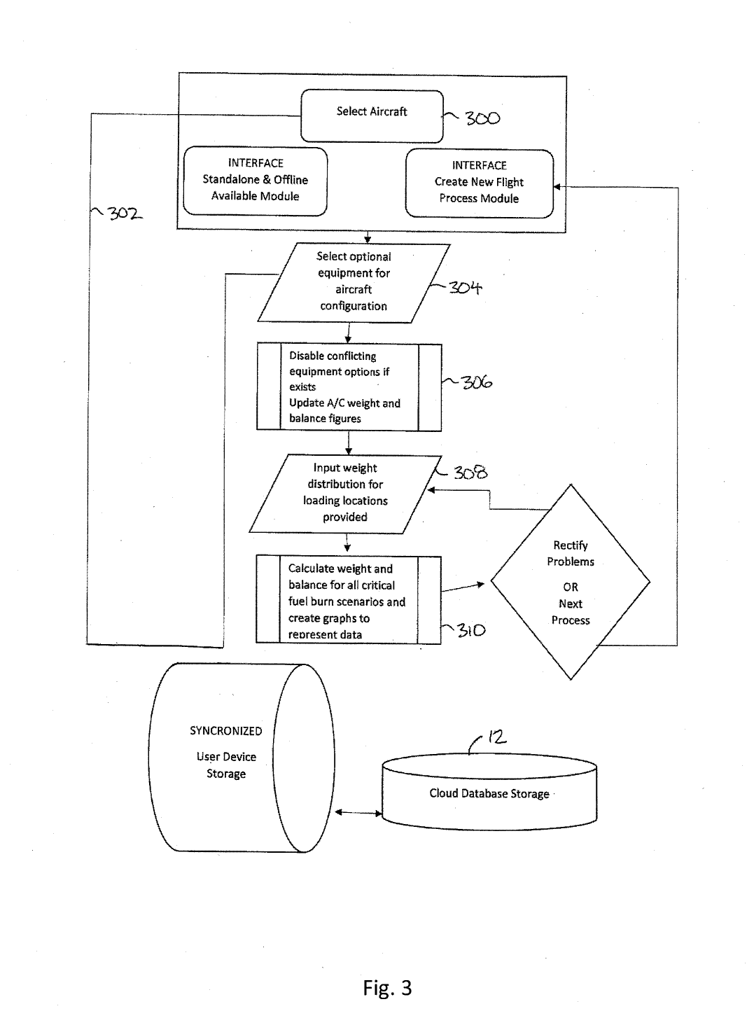

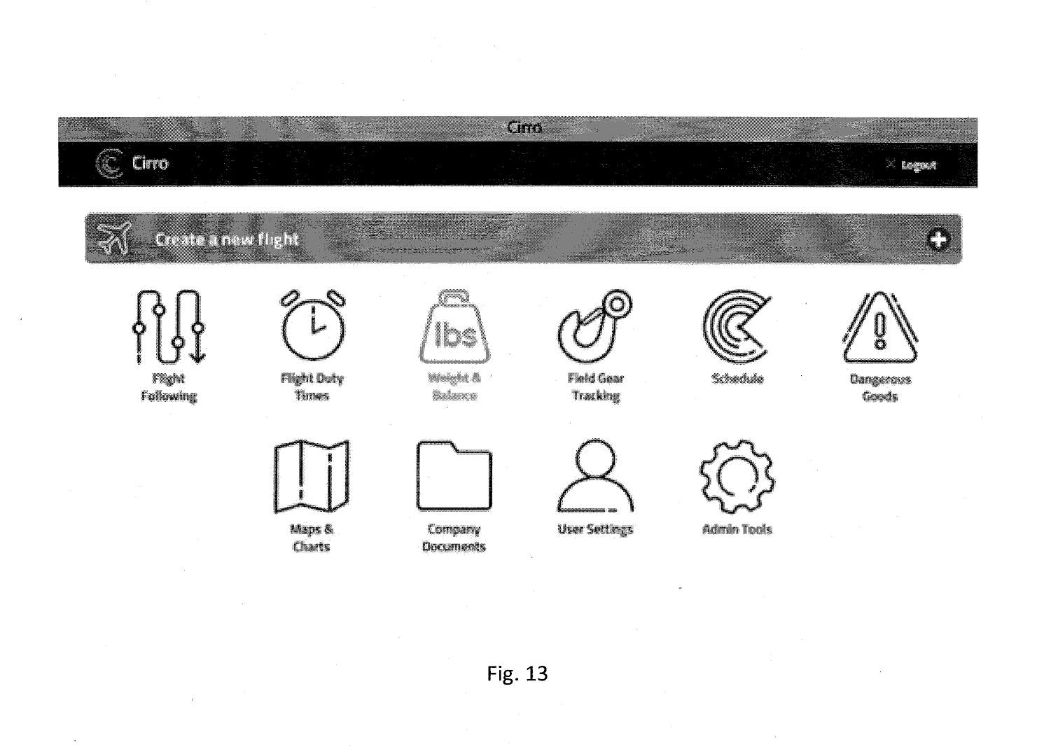

Turning now to operation of the pilot processing routine on the pilot computer device 16 as represented in FIG. 3, the pilot initially activates the pilot processing routine on their computer device which presents a menu as shown by the screenshot in FIG. 13. Upon activation of the routine on the pilot computer device 16, the pilot processing routine synchronizes all data on the pilot computer device with the weight and balance data from the central server including weight and balance specifications for each available aircraft and the associated equipment listing of optionally installed equipment associated with each aircraft. Once all data has been synchronized by connection over the communications network 15, as represented at step 302, the remainder of the pilot processing routine can function off-line and does not require further interaction over the communications network with the central server.

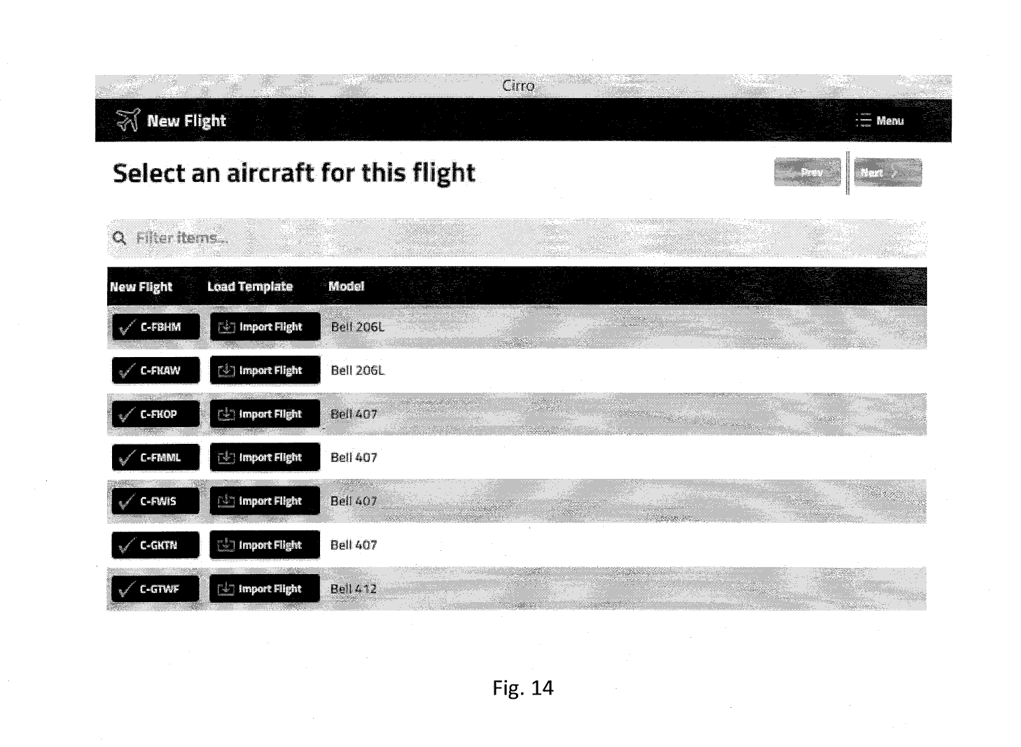

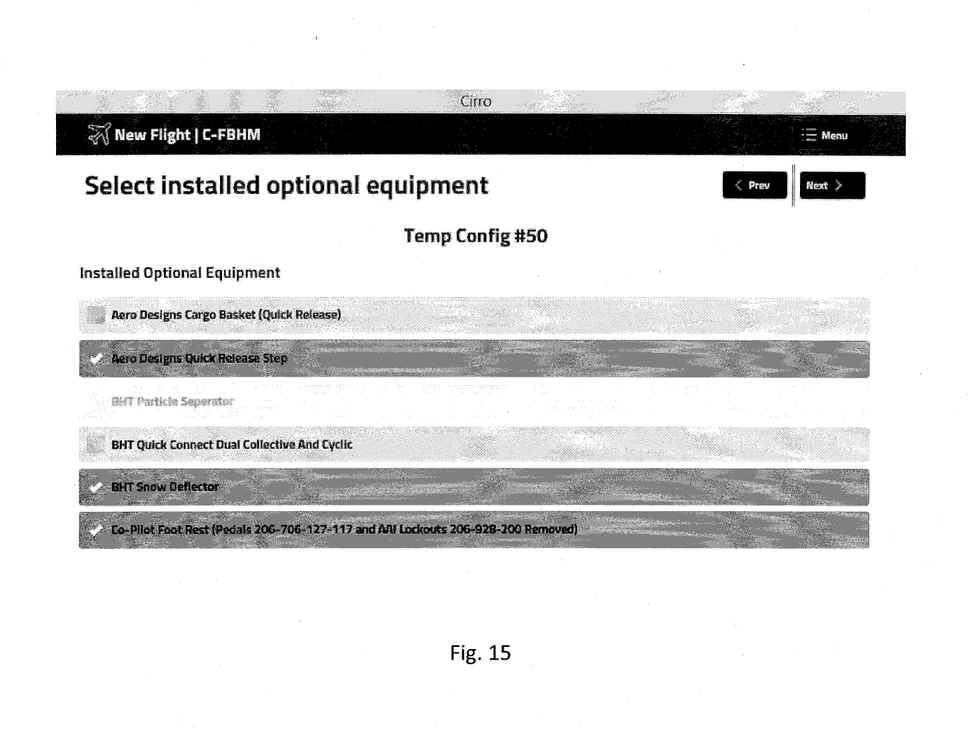

Prior to each flight, a pilot creates a new flight file by initially selecting an aircraft as shown by the screenshot in FIG. 14 and as represented at step 300. Once the aircraft is selected, the pilot processing routine prompts the pilot with a list of optional equipment to be optionally installed on the selected aircraft. The pilot then selects which equipment is installed on the current configuration of the aircraft as represented by step 304 and by the screenshot in FIG. 15. The pilot processing routine identifies which installation combination that the selected optional items correspond to and indicates the unique identification number of that installation configuration to the pilot in the screenshot in FIG. 15. As each optional item is selected, other optional items which conflict with the selected item are visually indicated to the pilot and prevent the pilot from selecting a conflicting configuration as represented by step 306 and as visually represented in the screenshot of FIG. 15.

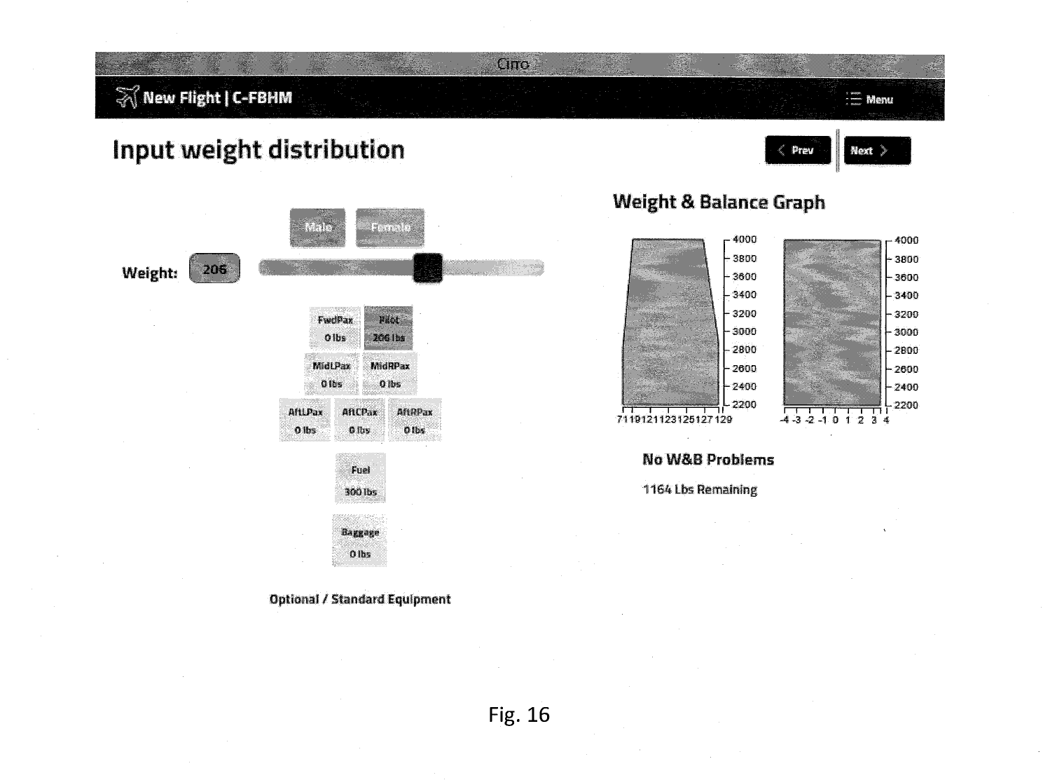

Based on the selections provided by the pilot above, the pilot processing routine generates a graphical representation of the layout of the aircraft with a graphical representation of a plurality of designated loading locations 400 shown in the screenshot of FIG. 16. Using the pilot computer device 16, the pilot has the ability to select each designated loading location which is identified as being either associated with a single passenger or a single designated cargo location, and input a corresponding weight for that location. The balance data relating to the horizontal arm and lateral arm for each loading location are already pre-designated by the layout of the aircraft such that addition of the input weight by the pilot is sufficient to provide a complete weight and balance specification for each designated loading location. The loading locations may also include a fuel location which is identified as being a consumable cargo item which varies as fuel is consumed throughout the aircraft flight. The input of weight distribution for loading locations is identified at step 308 in FIG. 3.

At step 310, the pilot processing routine generates graphical representations shown at the right side of FIG. 16 in which a first graphical representation includes weight on the vertical axis and fore-aft centre of gravity location on the horizontal axis, and a second graphical representation includes weight on the vertical axis and left-right centre of gravity location on the horizontal axis. On the two graphical representations, a boundary is plotted corresponding to the upper and lower weight limits for loading of the aircraft, and to balance limits in either the front to back direction or side to side direction respectively for each of the different permissible loading weights of the aircraft.

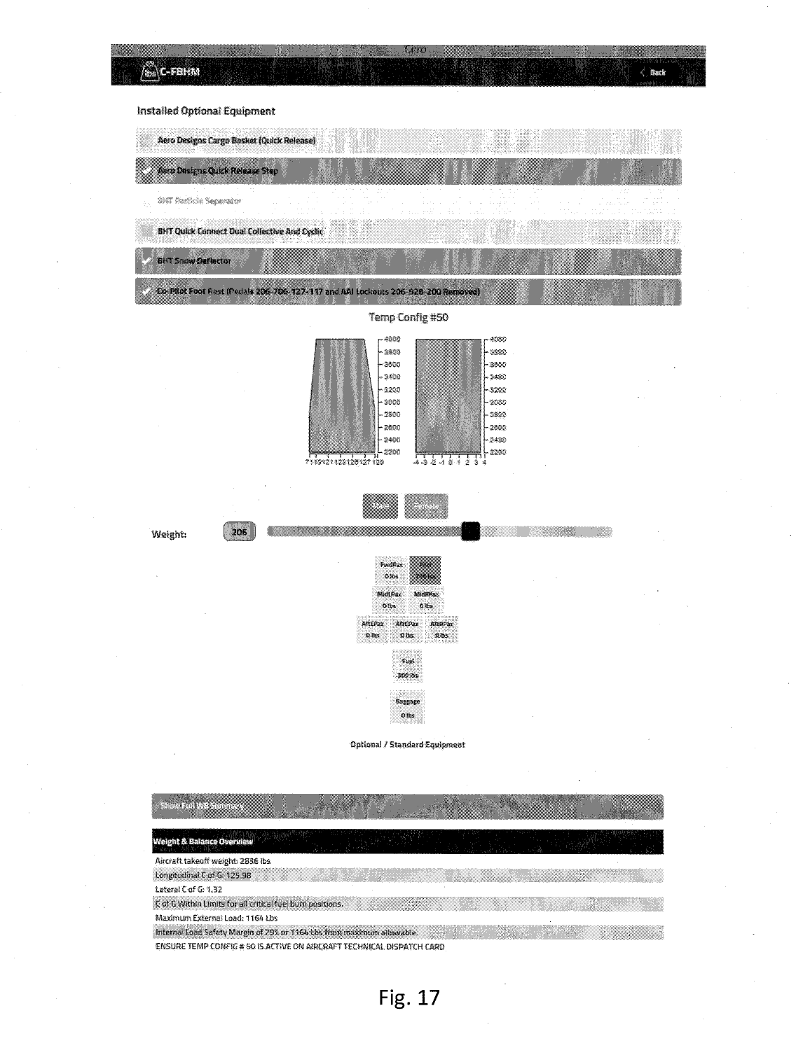

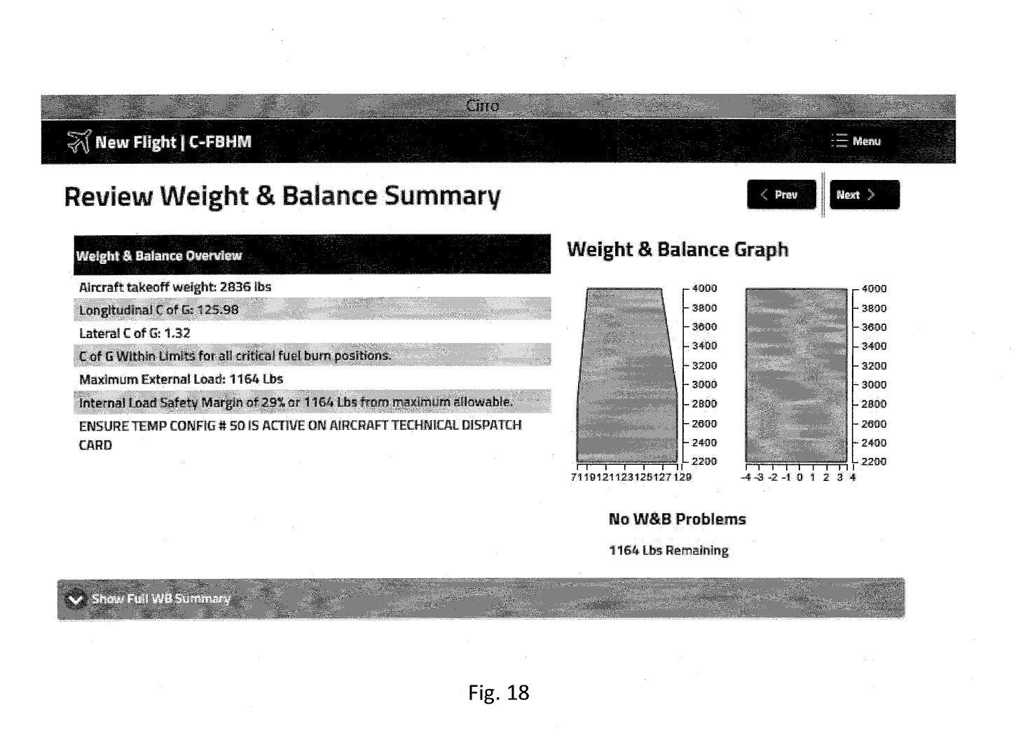

The pilot processing routine then further calculates an overall weight and balance specification for the configured aircraft which takes into consideration the already calculated weight and balance specification for the particular installation combination from the specification sheet for that aircraft based on the selections by the pilot, as well as the weight and balance data of all loadable items at the designated loading locations according to the pilot input at step 308, in addition to the variation of the weight and balance resulting from fuel being consumed from a full tank to an empty tank. The resulting varying weight and balance specification resulting from fuel burn is plotted as a line 402 on the first graphical representation and as a line 404 on the second graphical representation shown in FIG. 16. The pilot can then readily visually identify if the weight and balance specifications for all fuel burn scenarios of the aircraft as configured remain within the boundary limits for the designated aircraft. As shown by the screenshot of FIG. 17, the pilot processing routine is further adapted to display an overall summary of the weight and balance calculations by summarizing the optional installation equipment, the graphical representations of the fuel burn variation of the weight and balance specifications relative to applicable boundary limits, the graphical representation of the weight designated for each of the designated loading locations relative to the layout of the aircraft, as well as a numerical summary of the weight and balance of the configured aircraft. A further screenshot shown in FIG. 18 provides the pilot with a final summary of the weight and balance information for the pilot's review. If the pilot computer device remains connected with the communications network, the updated configuration of the loaded aircraft and the summarized weight and balance information for that particular flight file is updated back to the central server 12. If no communications network connection is available, the information remains only stored locally on the pilot computer device 16 for subsequent synchronization upon the next available communications network connection.

Since various modifications can be made in the invention as herein above described, it is intended that all matter contained in the accompanying specification shall be interpreted as illustrative only and not in a limiting sense.

1. An aircraft weight and balance data management system for communicating aircraft weight and balance data between at least one aircraft maintenance person and at least one pilot, the system comprising:
a central server adapted to store weight and balance data thereon including an aircraft listing of available aircraft, weight and balance data associated with each available aircraft in the aircraft listing, a master equipment listing of auxiliary equipment items available to be installed on one or more of the available aircraft in the aircraft listing, weight and balance data associated with each auxiliary equipment item, and for each aircraft, a selectable equipment listing of auxiliary equipment items which are available to be installed on that aircraft;
a user computer device associated with said at least one pilot;
a user computer device associated with said at least one aircraft maintenance person;
a communications interface associated with each one of the central server and the user computer devices and adapted to enable exchange of data between the central server and the user computer devices;
a maintenance processing routine executable on the user computer device associated with said at least one aircraft maintenance person so as to be adapted to:
i) receive updated weight and balance data input by said at least one maintenance person, and
ii) amend the weight and balance data of the aircraft listing and the master equipment listing stored on the central server using the communications interface according to the updated weight and balance data input by said at least one maintenance person;
a weight and balance routine executable on at least one of the computer server or the user computer device associated with said at least one aircraft maintenance person so as to be adapted to:
i) for each aircraft, calculate weight and balance specifications for each installation combination of the auxiliary equipment items which are available to be installed on that aircraft according to the selectable equipment listing using the corresponding weight and balance data stored on the server, and
ii) store the calculated weight and balance specifications of all installation combinations for each aircraft on the server;
a pilot processing routine executable on the user computer device associated with said at least one pilot so as to be adapted to:
i) receive the calculated weight and balance specifications for each aircraft of the aircraft listing from the central server using the communications interface,
ii) receive an aircraft selection through an input on the user computer device associated with the pilot corresponding to one selected aircraft from the available aircraft,
iii) receive an equipment selection through the input on the user computer device associated with the pilot so as to identify a corresponding installation combination of the auxiliary equipment items installed on the aircraft,
iv) receive weight and balance data relating to at least one loadable item through the input on the user computer device associated with the pilot, and
v) calculate a fuel burn variation of the weight and balance of the aircraft throughout a range of fuel burn using the weight and balance specifications of the corresponding installation combination and the weight and balance data relating to said at least one loadable item, and
vi) indicate on a display of the user computer device associated with the pilot if any portion of the fuel burn variation of the weight and balance falls outside of allowable weight and balance limits for the aircraft.

2. The system according to claim 1 wherein the pilot processing routine is further adapted to identify designated loading locations on a display of the user computer device associated with the pilot, and receive a weight associated with each designated location through the input of the user computer device associated with the pilot such that the designated loading locations and the associated input weight define said weight and balance data relating to at least one loadable item.

3. The system according to claim 2 wherein at least some of the designated loading locations correspond to individual passenger locations of the aircraft and the associated input weight corresponds to weight of a corresponding passenger.

4. The system according to claim 2 wherein at least one of the designated loading locations corresponds to a cargo location of the aircraft and the associated input weight corresponds to weight of a loadable cargo item.

5. The system according to claim 2 wherein the pilot processing routine is further adapted to graphically display the designated loading locations relative to a layout of the aircraft, and associate the input weight with each designated location by selecting the designated location on the graphical display.

6. The system according to claim 1 wherein the pilot processing routine is further adapted to display the weight and balance limits for the aircraft as a boundary on a graphical representation of weight versus balance, and plot the fuel burn variation of the weight and balance on said graphical representation to visually indicate if any portion of the plotted fuel burn variation of the weight and balance extends outside of the boundary.

7. The system according to claim 6 wherein the pilot processing routine is further adapted to display a first graphical representation of weight versus fore-aft balance with the fuel burn variation of the weight and balance plotted thereon and a second graphical representation of weight versus left-right balance with the fuel burn variation of the weight and balance plotted thereon.

8. The system according to claim 1 wherein the user computer device associated with the pilot communicates with the central server over a communications network, wherein the pilot processing routine is adapted to execute step i) only when the user computer device associated with the pilot is in communication with the communications network, and wherein the pilot processing routine is adapted to execute steps ii) through vi) even when the user computer device associated with the pilot is not in communication with the communications network.

9. The system according to claim 1 wherein the user computer device associated with the aircraft maintenance person communicates with the central server over a communications network.

10. The system according to claim 1 wherein the weight and balance routine is further adapted to display the calculated weight and balance specifications of all installation combinations in a matrix form on a specification sheet for each aircraft.

11. The system according to claim 1 wherein the weight and balance routine is further adapted to display the calculated weight and balance specifications of all installation combinations as a specification sheet for each aircraft, wherein the specification sheet further includes an indication of conflicting auxiliary equipment items for that aircraft.

12. The system according to claim 1 wherein the weight and balance routine is further adapted to display a unique identification number associated with each installation combination.

13. The system according to claim 1 wherein the weight and balance routine is further adapted to generate for each aircraft a graphical representation of weight versus balance and plot on the graphical representation: i) a rearwardmost center-of-gravity of all installation combinations relative to a permissible fore-aft range corresponding to the heaviest installation combination, and ii) a forwardmost center-of-gravity of all installation combinations relative to a permissible fore-aft range corresponding to the lightest installation.

14. An aircraft weight and balance data management system for communicating aircraft weight and balance data between at least one aircraft maintenance person and at least one pilot, the system comprising:
a central server adapted to store weight and balance data thereon including an aircraft listing of available aircraft, weight and balance data associated with each available aircraft in the aircraft listing, a master equipment listing of auxiliary equipment items available to be installed on one or more of the available aircraft in the aircraft listing, weight and balance data associated with each auxiliary equipment item, and for each aircraft, a selectable equipment listing of auxiliary equipment items which are available to be installed on that aircraft;
a user computer device associated with said at least one pilot;
a user computer device associated with said at least one aircraft maintenance person;
a communications interface associated with each one of the central server and the user computer devices and adapted to enable exchange of data between the central server and the user computer devices over a communications network;
a maintenance processing routine executable on the user computer device associated with said at least one aircraft maintenance person so as to be adapted to:
i) receive updated weight and balance data input by said at least one maintenance person, and
ii) amend the weight and balance data of the aircraft listing and the master equipment listing stored on the central server using the communications interface according to the updated weight and balance data input by said at least one maintenance person;
a weight and balance routine executable on at least one of the computer server or the user computer device associated with said at least one aircraft maintenance person so as to be adapted to:
i) for each aircraft, calculate weight and balance specifications for each installation combination of the auxiliary equipment items which are available to be installed on that aircraft according to the selectable equipment listing using the corresponding weight and balance data stored on the server, and
ii) store the calculated weight and balance specifications of all installation combinations as a specification sheet for each aircraft on the server;
a pilot processing routine executable on the user computer device associated with said at least one pilot so as to be adapted to:
i) receive the specification sheet for each aircraft from the central server using the communications interface,
ii) receive an aircraft selection through an input on the user computer device associated with the pilot corresponding to one selected aircraft from the available aircraft,
iii) display the specification sheet for the selected aircraft on the user computer device associated with the pilot.

15. The system according to claim 14 wherein the specification sheet for each aircraft includes the calculated weight and balance specifications for each installation combination displayed thereon as a matrix.

16. The system according to claim 14 wherein the specification sheet includes the calculated weight and balance specifications for each installation combination displayed thereon with an indication of conflicting auxiliary equipment items for that aircraft.

17. The system according to claim 14 wherein the specification sheet for each aircraft includes the calculated weight and balance specifications for each installation combination displayed thereon with a unique identification number associated with each installation combination.
